(19) United States
(12) Patent Application Publication
(10) Pub. No.: US 2022/0328837 A1
(43) Pub. Date: Oct. 13, 2022

(54) INTERLAYER MATERIAL FOR LITHIUM-SULFUR BATTERY, AND LITHIUM-SULFUR BATTERY

(71) Applicant: QILU UNIVERSITY OF TECHNOLOGY, Jinan, Shandong (CN)

(72) Inventors: Guowei ZHOU, Jinan (CN); Shaonan GU, Jinan (CN); Yinan WANG, Jinan (CN); Yanyan HE, Jinan (CN); Xiaoyi SONG, Jinan (CN); Bingjie LIU, Jinan (CN); Yongqiang REN, Jinan (CN)

(73) Assignee: QILU UNIVERSITY OF TECHNOLOGY, Jinan, Shandong (CN)

(21) Appl. No.: 17/615,974

(22) PCT Filed: May 7, 2021
(86) PCT No.: PCT/CN2021/092142

§ 371 Date: Dec. 2, 2021

(30) Foreign Application Priority Data
May 18, 2020 (CN) 202010421996.9

(51) Int. Cl. H01M 4/62; H01M 4/36; H01M 4/38; H01M 4/583; H01M 10/052; D21H 13/50; D21H 19/42; D21H 27/00; D21H 23/30; D21H 23/42

(52) U.S. Cl. CPC H01M 4/625; H01M 4/362; H01M 4/38; H01M 4/583; H01M 10/052; D21H 13/50; D21H 19/42; D21H 27/00; D21H 23/30; D21H 23/42; H01M 2004/028

(57) ABSTRACT

An interlayer material for a lithium-sulfur battery, and a lithium-sulfur battery, the interlayer material including electrically conductive MOF modified carbon fiber paper material between the separator and cathode accelerating electron transfer and having catalytic and barrier effect on lithium polysulfides. The paper material is prepared by: pretreatment of the paper by subjecting the carbon fiber paper to hydrophilic treatment; preparation of carbon fiber paper grown with Co₃(HITP)₂ including: complexing Co²⁺ and hexaiminotriphenylene on the paper surface, and allowing the product to grow in situ; and removal of structural impurities. The carbon fiber paper provides an electrically conductive substrate ensuring high-speed electrode movement between the cathode and separator; and Co₃(HITP)₂ grown on the carbon fiber paper provides sufficient polarity for the adsorption of lithium polysulfides, alleviating the shortcomings of the carbon material, and promotes a lithium polysulfides reaction through the catalysis of Co—N₄, inhibiting the shuttle effect of the polysulfides.

### TECHNICAL FIELD

The present invention relates to nano-material technologies, and particularly to a method for preparing an electrically conductive MOF modified carbon fiber carbon fiber paper interlayer material for lithium-sulfur battery and use thereof, which belong to the technical field of lithium-sulfur batteries.

### BACKGROUND

The description herein merely provides background information related to the present invention, and does not necessarily constitute the related technology.

Lithium-sulfur batteries have received great attention due to the fact that their theoretical capacity (1675 mAh/g) and energy density (2600 Wh/kg) are far greater than commercial lithium ion batteries (<300 mAh/gm, <420 Wh/kg), and thus have high research value and application prospects. However, lithium-sulfur batteries still face great challenges. The most major problem is the “shuttle effect” caused by the deposition of lithium polysulfides, intermediate products of the battery reaction, on the anode side after passing through the separator. The shuttle effect during the charge and discharge process of the battery mainly brings about three negative effects: (1) lowered coulombic efficiency of batteries; (2) serious reduction of capacity; and (3) fast loss of effective active material. As a result, the lithium-sulfur batteries are finally caused to have a low actual capacity and a drastically reduced service life, seriously hindering their practical application.

In recent reports on solving the shuttle effect of lithium-sulfur batteries, a method with simple process and controllable structure and performance is provided, which comprises introduces a polar inorganic sulfur-fixing material into the cathode of a lithium-sulfur battery, to inhibit the shuttle effect of polysulfides, thereby improving the cycle stability of the lithium-sulfur battery. However, the method also has disadvantages, mainly due to the fact that most inorganic sulfur-fixing materials are often non-conductive or have poor conductivity. Therefore, when added in a large amount, the internal resistance of the electrode itself will inevitably be increased largely, affecting the battery performance.

An interlayer is provided between the cathode and separator, and this structure can be used as a second current collector, to accelerate the transfer of electrons, improve the conductivity, and intercept the polysulfides to some extent. Base on this idea, more and more interlayer materials are gradually being applied to lithium-sulfur batteries. For example, the Chinese Patent Application Publication No. 109920957A (201910095425.8) discloses an interlayer material for lithium-sulfur batteries. In this patent, a polypropylene separator is used as a base layer of the interlayer, and bismuth telluride acts as an isolation layer, to form a barrier on the surface of the polypropylene separator, to inhibit the shuttle effect of lithium polysulfides. However, the present inventor finds that the material is a semiconductor, and the interlayer prepared from this material cannot fully exert the effect of accelerating electron transfer during the battery reaction, so battery performance is inevitably to be affected. Besides, the present inventor also finds that to improve the conductivity of the interlayer, the current interlayer is mostly based on carbon-based materials. However, the non-polar surface of carbon-based materials has very limited adsorption for polar lithium polysulfides. To improve the interception of the interlayer for lithium polysulfides, a non-polar sulfur-fixing material with poor conductivity has to be added, for example, metal oxides, and sulfides, etc., resulting in a decrease in the conductivity of the final interlayer material, and thus undesirable battery performance.

### SUMMARY

An object of the present invention is to provide an interlayer material for a lithium-sulfur battery, and a lithium-sulfur battery, to solve the technical problems of low conductivity and low efficiency in inhibiting the shuttle effect of lithium polysulfides of the existing interlayer materials and solve the technical problem of poor cycle stability of existing lithium-sulfur batteries.

Particularly, the following technical solutions are adopted in the present invention.

According to a first aspect of the invention, an interlayer material for a lithium-sulfur battery is provided, comprising an electrically conductive MOF modified carbon fiber paper material as the interlayer material for a lithium-sulfur battery, which is positioned between the separator and the cathode to accelerate electron transfer and have a catalytic and barrier effect on lithium polysulfides.

The electrically conductive MOF modified carbon fiber paper material which comprises a hydrophilic carbon fiber paper and a metal-organic framework material Co₃(HITP)₂. The metal-organic framework material Co₃(HITP)₂ is attached to the surface of carbon fibers in the hydrophilic carbon fiber paper.

The metal-organic framework material Co₃(HITP)₂ is in a flower-like morphology, characterized by a thin pillar, a more and more sharp petal from the front part, compact petals, ordered arrangement, a length of several microns, and a nano-scale width.

The conductive MOF modified carbon fiber paper material is prepared by a process comprising:

pretreatment of carbon fiber paper, comprising: subjecting the carbon fiber paper material to hydrophilic treatment by soaking the carbon fiber paper in a mixture of acetone, isopropanol and water, ultrasonically treating for 30-90 min, washing and drying, to obtain a hydrophilically treated carbon fiber paper;

preparation of carbon fiber paper grown with Co₃(HITP)₂, comprising: complexing divalent cobalt ions Co²⁺ and hexaiminotriphenylene on the surface of the hydrophilic carbon fiber paper, and allowing the product to grow in situ, where the reaction ligand HITP and a divalent cobalt salt are dissolved in a mixture of DMF and water before the reaction, the reaction temperature is 80-90° C., and the reaction time is 22-26 hrs; and

removal of structural impurities, comprising: removing unreacted Co²⁺ and HITP, the solvent DMF molecule, and/or free MOF molecules on the surface of carbon fiber paper.

According to a second aspect of the invention, a lithium-sulfur battery is provided, which has an anode that is lithium, a cathode that is a sulfur/carbon composite, and an interlayer that is the electrically conductive MOF modified carbon fiber paper material.

Compared with the related art known to the inventors, one of the technical solutions of the present invention has the following beneficial effects:

The present invention provides an electrically conductive MOF modified carbon fiber paper material. The carbon fiber paper is grown with a layer of MOF material, that is, Co₃(HITP)₂, after hydrophilic treatment. Co₃(HITP)₂-modified carbon fiber paper is highly electrically conductive.

The electrically conductive MOF, that is, Co₃(HITP)₂, modified carbon fiber paper prepared in the present invention is used as an interlayer material for a lithium-sulfur battery, in which the carbon fiber paper provides a necessary electrically conductive substrate to ensure the high-speed movement of electrons between the cathode and the separator; and Co₃(HITP)₂ grown on the carbon fiber paper can not only provide sufficient polarity for the adsorption of lithium polysulfides, to alleviate the shortcomings of the carbon material, but also promote the reaction of lithium polysulfides through the catalysis of Co—N₄, thus effectively inhibiting the shuttle effect of the polysulfides. More importantly, Co₃(HITP)₂ itself is also highly electrically conductive, and the overall electrical conductivity will not be greatly reduced after the functional material is modified onto the carbon substrate. When a lithium sheet is used as an anode, the lithium-sulfur battery is tested and verified to retain 93.7% of the capacity, after 600 cycles when the current is 1 C, thus having excellent cycle stability.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 shows SEM images of the hydrophilically treated carbon fiber paper and the flower-like Co₃(HITP)₂-modified carbon fiber paper in Example 1 of the present invention, including SEM images of (a) the carbon fiber paper and (b-d) the flower-like Co₃(HITP)₂ modified carbon fiber paper (at various amplification factors).

FIG. 2 shows an interlayer for a lithium-sulfur battery prepared with the Co₃(HITP)₂ modified carbon fiber paper in Example 1 of the present invention.

FIG. 3 shows the electrochemical impedance of the carbon fiber paper, the Co₃(HITP)₂ modified carbon fiber paper, and ZIF-67 (electrically non-conductive MOF having the same elements but a different structure) in Example 1 of the present invention.

FIG. 4 compares the charge and discharge cycles at 1 C of a lithium-sulfur battery with the Co₃(HITP)₂ modified carbon fiber paper in Example 1 of the present invention as an interlayer.

FIG. 5 shows an SEM image of the Cu₃(HITP)₂ modified carbon fiber paper in Comparative Example 2 of the present invention.

FIG. 6 shows an SEM image of Ni₃(HITP)₂ modified carbon fiber paper in Comparative Example 1 of the present invention.

### DETAILED DESCRIPTION

It should be noted that the following detailed descriptions are all illustrative and are intended to provide further descriptions of the present invention. Unless otherwise specified, all technical and scientific terms used herein have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is also intended to include the plural form unless the present invention clearly dictates otherwise. In addition, it should further be understood that, terms “comprise” and/or “include” used in this specification indicate that there are features, steps, operations, components, assemblies, and/or combinations thereof.

As described in the background, some existing interlayer materials have technical problems such as low electrical conductivity and low efficiency of inhibiting the shuttle effect of lithium polysulfides. To solve the above technical problems, in a first typical implementation of the present invention, an electrically conductive MOF modified carbon fiber paper material is provided, which comprises a hydrophilic carbon fiber paper and a metal-organic framework material Co₃(HITP)₂. The metal-organic framework material Co₃(HITP)₂ is attached to the surface of carbon fibers in the hydrophilic carbon fiber paper.

The Co₃(HITP)₂ modified carbon fiber paper material in the present invention is highly electrically conductive, and can not only ensure the high-speed transfer of electrons in the electrode, but also effectively inhibit the dissolution and loss of lithium polysulfides. This greatly improves the performance of the lithium-sulfur battery.

In some implementations of the present invention, the metal-organic framework material Co₃(HITP)₂ has a flower-like micromorphology, characterized by a thin pillar, a more and more sharp petal from the front part, compact petals, ordered arrangement, a length of several microns, a nano-scale width, and uniform length and width. The flower-like Co₃(HITP)₂ modified carbon fiber paper material is tested and verified to have a high electrical conductivity, and be able to effectively inhibit the dissolution and loss of lithium polysulfides, thus greatly improving the performance of the lithium-sulfur battery.

The inventors also studied related MOF modified carbon fiber paper materials formed by other transition metal ions (such as Ni, and Cu, etc.) and found that the Co₃(HITP)₂ carbon fiber paper material formed by complexing the metal cobalt ions with hexaiminotriphenylene has more excellent electrochemical performance, good morphology, and high controllability, which are conducive to industrial production.

To make the electrically conductive MOF modified carbon fiber paper material have more excellent electrical conductivity and improved efficiency in inhibiting the shuttle effect of lithium polysulfides, in some implementations of the present invention, the flower-like metal-organic framework material Co₃(HITP)₂, as a single layer, is evenly attached to the surface of carbon fibers in the hydrophilic carbon fiber paper.

Further, the flower-like metal-organic framework material Co₃(HITP)₂, as a single layer, is evenly grown on the surface of each carbon fiber in the hydrophilic carbon fiber paper.

In the present invention, to make Co²⁺ evenly distributed on the surface of carbon fiber, so as to allow the complexed product to grow, rather than stack and cover, on the surface of carbon fibers, the carbon fiber paper is hydrophilically treated to produce hydroxyl groups on its surface, which act as anchor points between carbon fibers and MOF. Only the growth on the surface of carbon fibers can ensure that the electrically conductive MOF is in close contact with the carbon matrix as much as possible, to reduce the contact resistance of different crystal planes, and ensure the electrical conductivity of the material.

In the present invention, the carbon fiber paper can be prepared by carbonizing polyacrylonitrile fibers, pitch fibers, viscose fibers or phenolic fibers. Carbon fiber paper prepared from polyacrylonitrile fibers is preferred. In some implementations of the present invention, carbon fibers having even pore size distribution is used. The carbon fiber paper has a porosity of 70-80%, a density of 40-90 g/m², and a thickness of 0.15-0.25 mm.

In a second typical implementation of the present invention, a method for preparing the electrically conductive MOF modified carbon fiber paper material is provided. The method includes the following steps:

pretreatment of carbon fiber paper, comprising: subjecting the carbon fiber paper material to hydrophilic treatment;

preparation of carbon fiber paper grown with Co₃(HITP)₂, comprising: complexing divalent cobalt ions Co²⁺ and hexaiminotriphenylene (HITP) on the surface of the hydrophilic carbon fiber paper, and allowing the product to grow in situ; and

removal of structural impurities, comprising: removing unreacted Co²⁺ and ligand HITP, the solvent DMF molecule and free MOF molecules on the surface of carbon fiber paper.

In the present invention, the carbon fibers can be hydrophilically treated through many methods. However, to better maintain the integrity of the carbon fibers and better improve the hydrophilicity-uniformity, in some implementations of the present invention, a preferred method is provided. The method includes the following steps:

soaking the carbon fiber paper in a mixture of acetone, isopropanol and water, ultrasonically treating for 30-90 min, washing and drying, to obtain a hydrophilically treated carbon fiber paper.

Further, in the mixture, the volume ratio of acetone, isopropanol and water is 1:1:1.

Further, a more preferred treatment method comprises the steps of soaking the carbon fiber paper in a mixture of acetone, isopropanol and water, sealing with a parafilm, ultrasonically treating for 60 min, taking out after the treatment and ultrasonically washing 3 times with deionized water, for 5 min each time, then ultrasonically washing 3 times with absolute ethanol, for 5 min each time, transferring the carbon fiber paper to a glass dish lined with filter paper, and drying in an oven at 100° C. for 12 hrs.

The hydrophilic treatment method is simple to operate, has remarkable effect and mild conditions, and requires no high-temperature and strong-acid treatment, which are conducive to the subsequent in-situ complexing reaction.

In the step of preparing the carbon fiber paper grown with Co₃(HITP)₂ in the present invention, to make the reaction raw materials more soluble, the reaction ligand HITP and a divalent cobalt salt are dissolved in a mixture of DMF and water (volume ratio 1:1) before the reaction.

Further, the cobalt salt is Co(OAc)₂.4H₂O.

To allow the complexing reaction to proceed more fully, Excess cobalt ions are used. In some implementations of the present invention, the molar ratio of HITP to Co²⁺ is 1:(1.5-2.5).

Further, the molar ratio of HITP to Co²⁺ is 1:2.

To at least enable Co₃(HITP)₂ to be attached to the surface of carbon fiber paper uniformly in a single layer, in some implementations of the present invention, a ratio of carbon fiber paper and the complexing material is provided. The use of (0.010-0.022) mmol HITP corresponding to a carbon fiber paper having an area of 180-220 mm² can ensure that each fiber on the carbon fiber paper is attached with a layer of flower-like Co₃(HITP)₂.

It is experimentally confirmed that when the concentration of the reactant is much greater than the concentration that the carbon fiber paper can receive, after the reaction, the weight of free MOF powder in the container is much greater than the weight grown on carbon fibers.

To promote the complexing reaction, and achieve an increased reaction efficiency, in some implementations of the present invention, the reaction temperature is 80-90° C., and the reaction time is 22-26 hrs.

Further, the reaction temperature is 85° C., and the reaction time is 24 hrs.

In the step of removing structural impurities in the present invention, the specific process includes: putting the carbon fiber paper attached with Co₃(HITP)₂ in water at 80-90° C. and standing for 22-26 hrs, during which the water is changed every 6-8 hrs; taking out the carbon fiber paper attached with Co₃(HITP)₂, transferring to a reactor with acetone (to avoid the volatilization of acetone at a high temperature), and standing in acetone at 80-90° C. for 22-26 hrs, during which the acetone is changed every 6-8 hrs; and finally drying at 60° C. for 24 hrs.

In the process of removing structural impurities in present invention, a high temperature (80-90° C.) is beneficial to the release of the solvent DMF molecule from the porous structure, but a higher temperature will destroy the MOF structure. By the process for removing structural impurities of the present invention, the cobalt ions, ligand, DMF molecules, and MOF molecules free on the surface of carbon fiber paper can be completely removed, so that the prepared carbon fiber paper material has a higher purity.

The method for preparing the electrically conductive MOF modified carbon fiber paper material of the present invention is simple, efficient, and environmentally friendly, and has easily controllable preparation process, mild conditions and low production cost, which are conducive to industrial production.

In a third typical implementation of the present invention, use of the electrically conductive MOF modified carbon fiber paper material in the preparation of lithium-sulfur batteries is used. Especially when used as an interlayer material, the electrochemical performance of the lithium-sulfur battery can be greatly improved.

In a fourth typical implementation of the present invention, an interlayer material for a lithium-sulfur battery is provided, which comprises an electrically conductive MOF modified carbon fiber paper material as the interlayer material for a lithium-sulfur battery, and is positioned between the separator and the cathode to accelerate electron transfer and have a catalytic and barrier effect on lithium polysulfides.

In a fifth typical implementation of the present invention, a lithium-sulfur battery is provided, which has an anode that is lithium, a cathode that is a sulfur/carbon composite, and an interlayer that is the electrically conductive MOF modified carbon fiber paper material.

In some implementations of the present invention, the sulfur is present in the cathode in an amount of 80 wt %.

To enable those skilled in the art to more clearly understand the technical solutions of the present invention, the technical solutions of the present invention will be described in detail below in conjunction with specific examples.

### EXAMPLE 1

A carbon fiber paper material grown with flower-like Co₃(HITP)₂ was produced in which divalent cobalt ions Co²⁺ were complexed with HITP on the surface of hydrophilic carbon fiber paper and grown in situ.

The material was prepared through a method comprising the following steps.

(1) Hydrophilic treatment of carbon fiber paper: A commercial carbon fiber paper (Phychemi (Hong Kong) Co., Ltd., Carbon Fiber Paper Model N0S1005) was cut by a slicer (diameter 16 mm) and stored for use. Each 10 ml of deionized water, acetone, and isopropanol were weighed and mixed well in a 50 ml beaker. A certain slices of carbon fiber paper were completely immersed in the mixture, and the beaker was sealed with paraffin sealing film and ultrasonicated for 60 min. The carbon fiber paper was taken out after the treatment and ultrasonically washed 3 times with deionized water, for 5 min each time, and then ultrasonically washed 3 times with absolute ethanol, for 5 min each time. The carbon fiber paper was transferred to a glass dish lined with filter paper, and dried in an oven at 100° C. for 12 hrs.

(2) Preparation of carbon fiber paper grown with flower-like Co₃(HITP)₂: Each 500 μL of DMF and deionized water were pipetted to a 20 ml glass flask and mixed well. HITP (0.02 mmol, 11.6 mg) and Co(OAc)₂.4H₂O (0.04 mmol, 10 mg) were weighed using an analytic balance, mixed and poured into the 20 ml glass flask, sealed and ultrasonicated for 10 min, the pretreated carbon fiber paper was immersed in the glass flask, and incubated in an oven at 85° C. for 24 hrs. The glass flask was removed, and cooled to room temperature. The carbon fiber paper was taken out rinsed with deionized water, to obtain the carbon fiber paper grown with flower-like Co₃(HITP)₂.

(3) Removal of structural impurities: Carbon fiber paper grown with Co₃(HITP)₂ was placed in a 20 ml glass flask, a suitable amount of deionized water was added, and sealed. The glass flask was allowed to stand in an oven at 85° C., during which the deionized water is changed every 8 hrs for a total of 3 times. Then, the carbon fiber paper grown with Co₃(HITP)₂ was placed in a reactor (prevent the vitalization of acetone), and a suitable amount of acetone was added. The glass flask was allowed to stand in an oven at 85° C., during which the acetone is changed every 8 hrs, for a total of 3 times. Finally, the carbon fiber paper was transferred to an oven and dried at 60° C. for 24 hrs.

### COMPARATIVE EXAMPLE 1

(1) Hydrophilic treatment of carbon fiber paper: The process was the same as that in Example 1.

(2) Preparation of carbon fiber paper grown with ZIF-67: Each 500 μL of DMF and deionized water were pipetted to a 20 ml glass flask and mixed well. Dimethylimidazole (0.02 mmol) and Co(OAc)₂.4H₂O (0.04 mmol) were weighed using an analytical balance, mixed, and poured into a 20 ml glass flask, sealed and ultrasonicated for 10 min. The pretreated carbon fiber paper was immersed in the glass flask, and incubated in an oven at 85° C. for 24 hrs. The glass flask was removed, and cooled to room temperature. The carbon fiber paper was taken out rinsed with deionized water, to obtain the carbon fiber paper grown with ZIF-67.

(3) Removal of structural impurities: The process was the same as that in Example 1.

### COMPARATIVE EXAMPLE 2

A method for preparing a carbon fiber paper material grown with Cu₃(HITP)₂ is provided. The method comprises the following steps:

(1) Hydrophilic treatment of carbon fiber paper: The treatment process was the same as that in Example 1.

(2) Preparation of carbon fiber paper grown with Cu₃(HITP)₂: Each 500 μL of DMF and deionized water were pipetted to a 20 ml glass flask and mixed well. HITP (0.02 mmol, 11.6 mg) and Cu(OAc)₂.H₂O (0.04 mmol, about 7.98 mg) were weighed using an analytic balance, mixed and poured into the 20 ml glass flask, sealed and ultrasonicated for 10 min. The pretreated carbon fiber paper was immersed in the glass flask, and incubated in an oven at 85° C. for 24 hrs. The glass flask was removed, and cooled to room temperature. The carbon fiber paper was taken out rinsed with deionized water, to obtain the carbon fiber paper grown with Cu₃(HITP)₂.

(3) Removal of structural impurities: The treatment process was the same as that in Example 1.

### COMPARATIVE EXAMPLE 3

A method for preparing a carbon fiber paper material grown with Ni₃(HITP)₂ is provided. The method comprises the following steps:

(1) Hydrophilic treatment of carbon fiber paper: The treatment method was the same as that in Example 1.

(2) Preparation of carbon fiber paper grown with Ni₃(HITP)₂: Each 500 μL of DMF and deionized water were pipetted to a 20 ml glass flask and mixed well. HITP (0.02 mmol, 11.6 mg) and Ni(OAc)₂.4H₂O (0.04 mmol, about 9.95 mg) were weighed using an analytic balance, mixed and poured into the 20 ml glass flask, sealed and ultrasonicated for 10 min. The pretreated carbon fiber paper was immersed in the glass flask, and incubated in an oven at 85° C. for 24 hrs. The glass flask was removed, and cooled to room temperature. The carbon fiber paper was taken out rinsed with deionized water, to obtain the carbon fiber paper grown with Ni₃(HITP)₂.

(3) Removal of structural impurities: The treatment process was the same as that in Example 1.

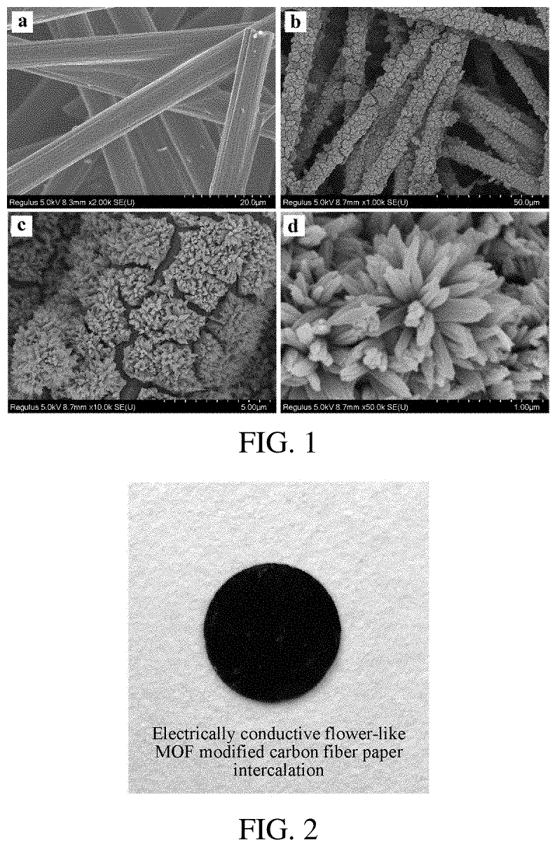

FIG. 1 shows SEM images of the carbon fiber paper and the flower-like Co₃(HITP)₂-modified carbon fiber paper in Example 1. It can be seen from FIG. 1 that a layer of flower-like Co₃(HITP)₂ is evenly grown on the surface of carbon fibers. The flower-like morphology is characterized by a thin pillar, a more and more sharp petal from the front part, compact petals, ordered arrangement, a regular shape, a length of several microns, a nano-scale width, and uniform length and width.

FIG. 2 shows an interlayer for a lithium-sulfur battery prepared with the Co₃(HITP)₂ modified carbon fiber paper in Example 1 of the present invention.

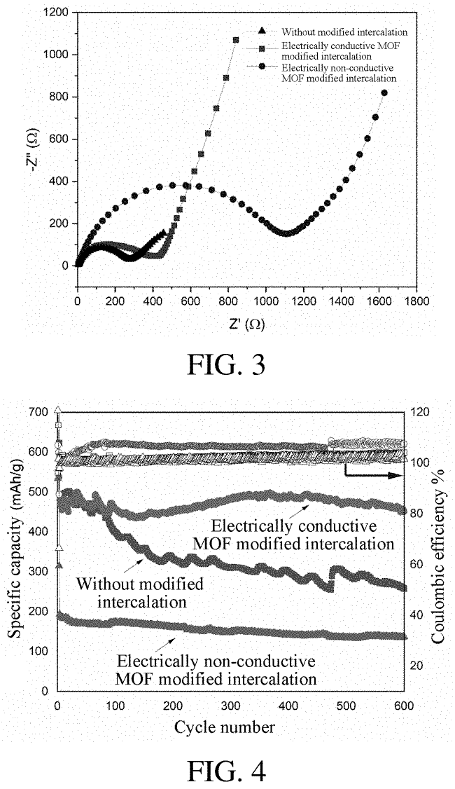

FIG. 3 shows the electrochemical impedance of the carbon fiber paper, the Co₃(HITP)₂ modified carbon fiber paper, and ZIF-67 (electrically non-conductive MOF having the same elements but a different structure) in Example 1 of the present invention. It can be seen from FIG. 3 that after the electrically conductive carbon fiber paper is modified with electrically conductive Co₃(HITP)₂ on the surface, the electrochemical resistance of the battery does not change much, which is conducive to the electrochemical reaction. In contrast, after modification with the electrically non-conductive ZIF-67, the electrochemical resistance changes greatly. This reduces the electrical conductivity of the interlayer material.

FIG. 4 compares the charge and discharge cycles at 1 C of a lithium-sulfur battery with the Co₃(HITP)₂ modified carbon fiber paper in Example 1 of the present invention as an interlayer, where the battery anode is a metal lithium sheet, the cathode is 80 wt % sulfur/carbon composite, the separator is Celgard 2325 separator, 40 μL electrolyte solution is filled, and the charge and discharge voltage is between 1.7-2.8 V. It can be seen from FIG. 4 that the lithium-sulfur battery with Co₃(HITP)₂ modified carbon fiber paper as an interlayer has better charge and discharge performance.

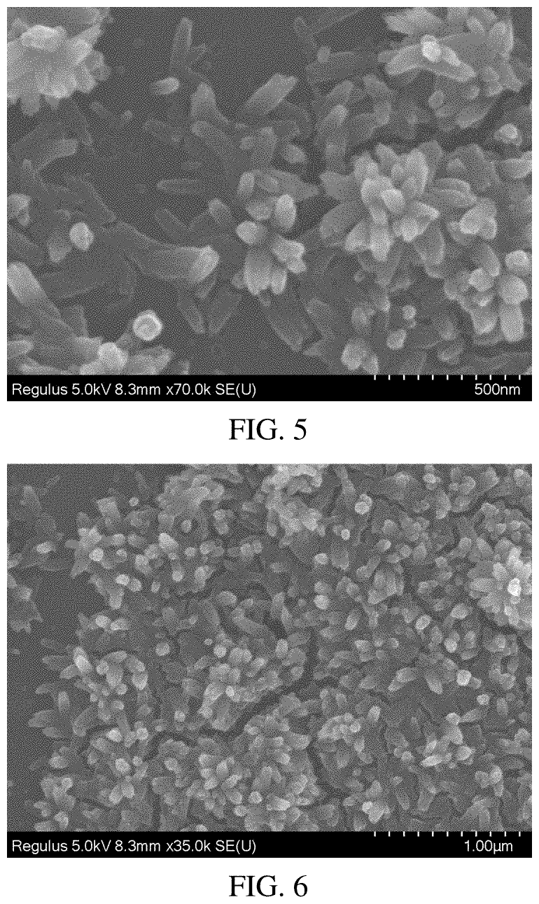

FIG. 5 shows an SEM image of Cu₃(HITP)₂ modified carbon fiber paper in Comparative Example 2. Compared with FIG. 1, the morphology and distribution are poor, and the amount attached is low. Compared with the flower-like Co₃(HITP)₂ modified carbon fiber paper material in Example 1, the preparation efficiency and electrochemical performance of this material are low.

FIG. 6 shows an SEM image of Ni₃(HITP)₂ modified carbon fiber paper in Comparative Example 3 of the present invention. Compared with FIG. 1, the flower-like morphology is not obvious, the petals are not uniform in length, are unevenly distributed, and are generally relatively sparse, and the amount attached is low. Compared with the flower-like Co₃(HITP)₂ modified carbon fiber paper material in Example 1, the preparation efficiency and electrochemical performance of this material are low.

### EXAMPLE 2

A carbon fiber paper material grown with flower-like Co₃(HITP)₂ was provided. The material was prepared through a process comprising the following steps:

(1) Hydrophilic treatment of carbon fiber paper: A commercial carbon fiber paper was cut by a slicer (diameter 16 mm) and stored for use. Each 12 ml of deionized water, acetone, and isopropanol were weighed and mixed well in a 50 ml beaker. A certain slices of carbon fiber paper were completely immersed in the mixture, and the beaker was sealed with paraffin sealing film and ultrasonicated for 75 min. The carbon fiber paper was taken out after the treatment and ultrasonically washed 3 times with deionized water, for 4 min each time. and then ultrasonically washed 3 times with absolute ethanol, for 4 min each time. The carbon fiber paper was transferred to a glass dish lined with filter paper, and dried in an oven at 100° C. for 13 hrs.

(2) Preparation of carbon fiber paper grown with flower-like Co₃(HITP)₂: Each 500 μL of DMF and deionized water were pipetted to a 20 ml glass flask and mixed well. HITP (0.022 mmol, 12.76 mg) and Co(OAc)₂.4H₂O (0.044 mmol, 11 mg) were weighed, mixed and poured into the 20 ml glass flask, sealed and ultrasonicated for 10 min. The pretreated carbon fiber paper was immersed in the glass flask, and incubated in an oven at 80° C. for 25 hrs. The glass flask was removed, and cooled to room temperature. The carbon fiber paper was taken out rinsed with deionized water, to obtain the carbon fiber paper grown with flower-like Co₃(HITP)₂.

(3) Removal of structural impurities: Carbon fiber paper grown with Co₃(HITP)₂ was placed in a 20 ml glass flask, a suitable amount of deionized water was added, and sealed. The glass flask was allowed to stand in an oven at 85° C., during which the deionized water is changed every 8 hrs for a total of 3 times. Then, the carbon fiber paper grown with Co₃(HITP)₂ was placed in a reactor (prevent the vitalization of acetone), and a suitable amount of acetone was added. The glass flask was allowed to stand in an oven at 85° C., during which the acetone is changed every 8 hrs, for a total of 3 times. Finally, the carbon fiber paper was transferred to an oven and dried at 60° C. for 24 hrs.

### EXAMPLE 3

A carbon fiber paper material grown with flower-like Co₃(HITP)₂ was provided. The material was prepared through a process comprising the following steps:

(1) Hydrophilic treatment of carbon fiber paper: A commercial carbon fiber paper was cut by a slicer (diameter 16 mm) and stored for use. Each 10 ml of deionized water, acetone, and isopropanol were weighed and mixed well in a 50 ml beaker. A certain slices of carbon fiber paper were completely immersed in the mixture, and the beaker was sealed with paraffin sealing film and ultrasonicated for 55 min. The carbon fiber paper was taken out after the treatment and ultrasonically washed 3 times with deionized water, for 5 min each time. and then ultrasonically washed 3 times with absolute ethanol, for 5 min each time. The carbon fiber paper was transferred to a glass dish lined with filter paper, and dried in an oven at 100° C. for 10 hrs.

(2) Preparation of carbon fiber paper grown with flower-like Co₃(HITP)₂: Each 500 μL of DMF and deionized water were pipetted to a 20 ml glass flask and mixed well. HITP (0.0182 mmol, 10.44 mg) and Co(OAc)₂.4H₂O (0.036 mmol, 9 mg) were weighed, mixed and poured into the 20 ml glass flask, sealed and ultrasonicated for 10 min. The pretreated carbon fiber paper was immersed in the glass flask, and incubated in an oven at 90° C. for 22 hrs. The glass flask was removed, and cooled to room temperature. The carbon fiber paper was taken out rinsed with deionized water, to obtain the carbon fiber paper grown with flower-like Co₃(HITP)₂.

(3) Removal of structural impurities: Carbon fiber paper grown with Co₃(HITP)₂ was placed in a 20 ml glass flask, a suitable amount of deionized water was added, and sealed. The glass flask was allowed to stand in an oven at 85° C., during which the deionized water is changed every 8 hrs for a total of 3 times. Then, the carbon fiber paper grown with Co₃(HITP)₂ was placed in a reactor (prevent the vitalization of acetone), and a suitable amount of acetone was added. The glass flask was allowed to stand in an oven at 85° C., during which the acetone is changed every 8 hrs, for a total of 3 times. Finally, the carbon fiber paper was transferred to an oven and dried at 60° C. for 24 hrs.

The foregoing descriptions are merely preferred embodiments of the present invention and are not intended to limit the present invention. A person skilled in the art may make various alterations and variations to the present invention. Any modification, equivalent replacement, or improvement made within the spirit and principle of the present invention shall fall within the protection scope of the present invention.

1. An interlayer material for a lithium-sulfur battery, comprising an electrically conductive MOF modified carbon fiber paper material as the interlayer material for a lithium-sulfur battery, which is positioned between the separator and the cathode to accelerate electron transfer and have a catalytic and barrier effect on lithium polysulfides,
wherein the electrically conductive MOF modified carbon fiber paper material comprises a hydrophilic carbon fiber paper and a metal-organic framework material Co₃(HITP)₂, wherein the metal-organic framework material Co₃(HITP)₂ is attached to the surface of carbon fibers in the hydrophilic carbon fiber paper; and
the metal-organic framework material Co₃(HITP)₂ is in a flower-like morphology, wherein a thin pillar, a more and more sharp petal from the front part, compact petals, ordered arrangement, a length of several microns, a nano-scale width; and
the conductive MOF modified carbon fiber paper material is prepared by a process comprising:
pretreatment of carbon fiber paper, comprising: subjecting the carbon fiber paper material to hydrophilic treatment by soaking the carbon fiber paper in a mixture of acetone, isopropanol and water, ultrasonically treating for 30-90 min, washing and drying, to obtain a hydrophilically treated carbon fiber paper;
preparation of carbon fiber paper grown with Co₃(HITP)₂, comprising:
complexing divalent cobalt ions Co²⁺ and hexaiminotriphenylene on the surface of the hydrophilic carbon fiber paper, and allowing the product to grow in situ, wherein the reaction ligand HITP and a divalent cobalt salt are dissolved in a mixture of DMF and water before the reaction, the reaction temperature is 80-90° C., and the reaction time is 22-26 hrs; and
removal of structural impurities, comprising: removing unreacted Co²⁺ and HITP, the solvent DMF molecule, and/or free MOF molecules on the surface of carbon fiber paper.

2. The interlayer material for a lithium-sulfur battery according to claim 1, wherein the flower-like metal-organic framework material Co₃(HITP)₂, as a single layer, is evenly attached to the surface of carbon fibers in the hydrophilic carbon fiber paper.

3. The interlayer material for a lithium-sulfur battery according to claim 1, wherein the carbon fiber paper has a porosity of 70-80%, a density of 40-90 g/m², and a thickness of 0.15-0.25 mm.

4. The interlayer material for a lithium-sulfur battery according to claim 1, wherein in the mixture, the volume ratio of acetone, isopropanol and water is 1:1:1.

5. The interlayer material for a lithium-sulfur battery according to claim 1, wherein the carbon fiber paper is hydrophilically treated through a process specifically comprising the steps of soaking the carbon fiber paper in a mixture of acetone, isopropanol and water, sealing with a parafilm, ultrasonically treating for 60 min, taking out after the treatment and ultrasonically washing 3 times with deionized water, for 5 min each time, then ultrasonically washing 3 times with absolute ethanol, for 5 min each time, transferring the carbon fiber paper to a glass dish lined with filter paper, and drying in an oven at 100° C. for 12 hrs.

6. The interlayer material for a lithium-sulfur battery according to claim 1, wherein the cobalt salt is Co(OAc)₂.4H₂O.

7. The interlayer material for a lithium-sulfur battery according to claim 1, wherein the molar ratio of HITP to Co²⁺ is 1:(1.5-2.5).

8. The interlayer material for a lithium-sulfur battery according to claim 7, wherein the molar ratio of HITP to Co²⁺ is 1:2.

9. The interlayer material for a lithium-sulfur battery according to claim 1, wherein (0.010-0.022) mmol HITP is used corresponding to a carbon fiber paper having an area of 180-220 mm².

10. The interlayer material for a lithium-sulfur battery according to claim 1, wherein the reaction temperature is 85° C., and the reaction time is 24 hrs.

11. The interlayer material for a lithium-sulfur battery according to claim 1, wherein the process for removing the structural impurities comprises: putting the carbon fiber paper attached with Co₃(HITP)₂ in water at 80-90° C. and standing for 22-26 hrs, during which the water is changed every 6-8 hrs; taking out the carbon fiber paper attached with Co₃(HITP)₂, and standing in acetone at 80-90° C. for 22-26 hrs, during which the acetone is changed every 6-8 hrs; and finally drying.

12. A lithium-sulfur battery, having an anode that is lithium, a cathode that is a sulfur/carbon composite, and the interlayer material for a lithium-sulfur battery according to claim 1 as an interlayer.
